(19) United States
(12) Patent Application Publication
(10) Pub. No.: US 2026/0348467 A1
(43) Pub. Date: Nov. 5, 2026

(54) SYNCHRONOUS CAM DRIVETRAIN

(71) Applicant: Radius 1, LLC, St. George, UT (US)

(72) Inventor: Andrew Kerlin, St. George, UT (US)

(73) Assignee: Radius 1, LLC, St. George, UT (US)

(21) Appl. No.: 19/667,317

(22) Filed: May 4, 2026

Related U.S. Application Data
(60) Provisional application No. 63/799,192, filed on May 2, 2025.

(51) Int. Cl. F16H 53/00; F16H 3/78; F16H 57/12

(52) U.S. Cl. CPC F16H 53/00; F16H 3/78; F16H 57/12

(57) ABSTRACT

A synchronous cam drivetrain includes a plurality of shafts each having a cam lobe at an end thereof, all cam lobes having a same eccentricity with a direction of the eccentricity positioned in a same direction. A link gear has receiving housing holes corresponding in number to the cam lobes, each receiving housing hole separated from adjacent receiving housing holes by distances equal to shaft separation distances. The cam lobes are fitted within the receiving housing holes. An internal ring gear is coupled to the link gear, and a single output shaft is coupled to the internal ring gear. As the shafts rotate, the shafts are synchronized by the link gear such that all shafts rotate unidirectionally, and the rotating shafts cause the link gear to travel in a substantially non-rotative epicyclic orbit with a radius equal to the eccentricity of the cam lobes.

### CROSS-REFERENCE TO RELATED APPLICATIONS

This application claims the benefit of U.S. Application No. 63/799,192, filed May 2, 2025, which is hereby incorporated by reference in its entirety.

### FIELD OF INVENTION

The present disclosure relates to drivetrains.

### BACKGROUND

Various mechanical systems utilize multiple rotating shafts that operate in coordination to perform work. In some applications, it is desirable to combine the rotational output from multiple shafts into a single output driveshaft while maintaining synchronization between the shafts. Such applications may include compressors, expanders, pumps, and other rotating machinery where precise timing relationships between rotating components affect operational efficiency, longevity, and performance.

Conventional approaches to synchronizing and combining output from multiple shafts include gears, belts, chains, and crank arm arrangements. Each of these approaches presents certain tradeoffs with respect to synchronization precision, torque carrying capacity, noise characteristics, and service life.

Gear-based synchronization systems may exhibit backlash, which refers to relative motion between meshing gear teeth. Backlash can reduce synchronization precision between shafts. While anti-backlash gear configurations exist that preload gears to reduce or eliminate backlash, such configurations may introduce increased friction, noise, and wear.

Belt-driven synchronization systems are commonly employed for timing applications. However, toothed timing belts that form continuous loops may have seams or joints that create inconsistencies in belt tooth pitch, which can affect synchronization precision. Timing belt systems may also exhibit noise at higher operating speeds, and load carrying capacity may be constrained by belt width and size. Serpentine belts, which typically take the form of multi-ribbed belts having ribs extending lengthwise along the belt, are commonly employed in belt-driven powertrain arrangements to address various belt limitations. Such serpentine belt configurations are usually utilized in asynchronous drive applications, as they transmit torque by frictional engagement rather than by positive tooth engagement and therefore do not provide maintained synchronization under varying load conditions.

Chain-driven systems generally offer greater load carrying capacity and durability compared to belt systems, but may provide less precise synchronization than other approaches.

Crank arm arrangements can provide improved synchronization and reduced noise compared to gears, belts, and chains. However, cantilevered crank arm configurations may experience twisting, deformation, or deflection under load, which can result in uneven loading on bearings. Such uneven loading may lead to premature wear, heat generation, and reduced service life, particularly in high-load applications. Other types of synchronization drivetrains can also synchronize the shafts, but they may ultimately draw power from one of the synchronized shafts. This puts extra strain on the bearings of that synchronized output shaft, as it must handle the combined load of all shafts in the drivetrain.

Accordingly, there remains a need in drivetrain configurations that can provide precise synchronization between multiple rotating shafts while accommodating high torque loads and maintaining even and equal bearing loading. The present disclosure seeks to solve these and other problems.

### SUMMARY

This summary is provided to introduce a selection of concepts in a simplified form that are further described below in the detailed description. This summary is not intended to identify key features or essential features of the claimed subject matter.

According to some aspects of the present disclosure, a synchronous cam drivetrain is provided. The synchronous cam drivetrain includes a plurality of shafts, each shaft having a cam lobe at an end thereof. All cam lobes have the same eccentricity, and the direction of the eccentricity for all cam lobes is positioned in the same direction. The synchronous cam drivetrain includes a link gear having a plurality of receiving housing holes to receive cam lobes. The number of receiving housing holes corresponds to the number of cam lobes, with each hole separated from one another by distances equal to shaft separation distances. The plurality of cam lobes is fitted within the receiving housing holes of the link gear. As the shafts rotate, the shafts are synchronized by the link gear and rotate unidirectionally. The rotating shafts cause the link gear to travel in a substantially non-rotative epicyclic orbit with a radius equal to the eccentricity of the cam lobes. The link gear is mated to an internal ring gear. The synchronous cam drivetrain includes a single output shaft coupled to the internal ring gear.

According to some aspects of the present disclosure, the synchronous cam drivetrain may include one or more of the following features. The cam lobes, bearings, link gear, and internal ring gear may be arranged along a common plane. Counterbalance weights may be positioned on planes located on either side of a balancing plane. Bearings may be positioned between the cam lobes and the receiving housing holes of the link gear. The bearings may be preloaded to reduce or eliminate backlash. The single output shaft may be coupled to a generator, motor, or alternator. A gear box may be positioned between the single output shaft and the generator, motor, or alternator.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a front perspective view of a synchronous cam drivetrain assembly, according to aspects of the present disclosure.

FIG. 2 illustrates a right-side elevation side view of a synchronous cam drivetrain assembly, according to aspects of the present disclosure.

FIG. 3 illustrates a top plan view of a synchronous cam drivetrain assembly, according to aspects of the present disclosure.

FIG. 4 illustrates a front perspective view of shafts, rotors, and endbells of a synchronous cam drivetrain assembly, according to aspects of the present disclosure.

FIG. 5 illustrates a perspective view of cam lobes on shafts of a synchronous cam drivetrain assembly, according to aspects of the present disclosure.

FIG. 6 illustrates a perspective view of bearings on cam lobes of a synchronous cam drivetrain assembly, according to aspects of the present disclosure.

FIG. 7A illustrates a front perspective view of a synchronous cam drivetrain assembly with an output adapter plate removed therefrom showing a link gear and an internal ring gear exploded from the assembly, and other components of a synchronous cam drivetrain assembly, according to aspects of the present disclosure.

FIG. 7B illustrates a front perspective view of a synchronous cam drivetrain assembly with an output adapter plate removed therefrom showing a link gear, an internal ring gear, and other components of a synchronous cam drivetrain assembly, according to aspects of the present disclosure.

FIG. 8 illustrates a left side elevation partial cutaway view of a synchronous cam drivetrain assembly, according to aspects of the present disclosure.

FIG. 9 illustrates a perspective cross-sectional view of a synchronous cam drivetrain assembly, according to aspects of the present disclosure.

FIG. 10 illustrates a front elevation view of an internal ring gear, link gear, and other components arranged in a first, starting position, according to aspects of the present disclosure.

FIG. 11 illustrates a front elevation view of an internal ring gear, link gear, and other components arranged in a second, rotated position, according to aspects of the present disclosure.

FIG. 12 illustrates a front cross-section of a plurality of helical rotors meshed with one another of a synchronous cam drivetrain assembly, according to aspects of the present disclosure.

FIG. 13 illustrates a front elevation view of a synchronous cam drivetrain assembly comprising a chain and sprocket configuration in a first, start position, according to aspects of the present disclosure.

FIG. 14 illustrates a front elevation view of a synchronous cam drivetrain assembly comprising a chain and sprocket configuration, in a second, rotated position according to aspects of the present disclosure.

FIG. 15 illustrates a front elevation view of a synchronous cam drivetrain assembly comprising a modified cycloidal drive in a first, start position according to aspects of the present disclosure.

FIG. 16 illustrates a top, front perspective view of a synchronous cam drivetrain assembly comprising a modified cycloidal drive in a first, start position according to aspects of the present disclosure.

FIG. 17 illustrates a front elevation of a synchronous cam drivetrain assembly comprising a modified cycloidal drive in a second, rotated position according to aspects of the present disclosure.

### DETAILED DESCRIPTION

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

The present disclosure describes a synchronous cam drivetrain configured to synchronize a plurality of rotating shafts and combine rotational output from the plurality of shafts into a single output shaft. The synchronous cam drivetrain may utilize cam lobes positioned at ends of the plurality of shafts, with each cam lobe having the same eccentricity and with the direction of eccentricity for all cam lobes positioned in the same direction. The cam lobes may be fitted within a common link gear having receiving housing holes corresponding in number to the cam lobes. The receiving housing holes may be separated from one another by distances equal to shaft separation distances.

As the plurality of shafts rotate, the common link gear may synchronize the shafts such that all shafts rotate unidirectionally. The rotating shafts may cause the link gear to travel in a substantially non-rotative epicyclic orbit with a radius equal to the eccentricity of the cam lobes. The link gear may be mated to an internal ring gear, and a single output shaft may be coupled to the internal ring gear to receive combined rotational output from the synchronized shafts.

In some aspects, the synchronous cam drivetrain may arrange the cam lobes, bearings, link gear, and internal ring gear along a common plane. This coplanar arrangement may position torque forces along the common plane, which may reduce or eliminate moments that could otherwise cause twisting, distortion, or deflection in cantilevered configurations. In some cases, bearings may be positioned between the cam lobes and the receiving housing holes of the link gear. The bearings may be preloaded to reduce or eliminate backlash, which may improve synchronization precision between the plurality of shafts.

In some aspects, counterbalance weights may be positioned on planes located on either side of a balancing plane to provide symmetrical balance correction. The single output shaft may be coupled to a generator, motor, an alternator, or other rotating machinery. In some cases, a gear box may be positioned between the single output shaft and the generator or alternator to adjust output shaft speed.

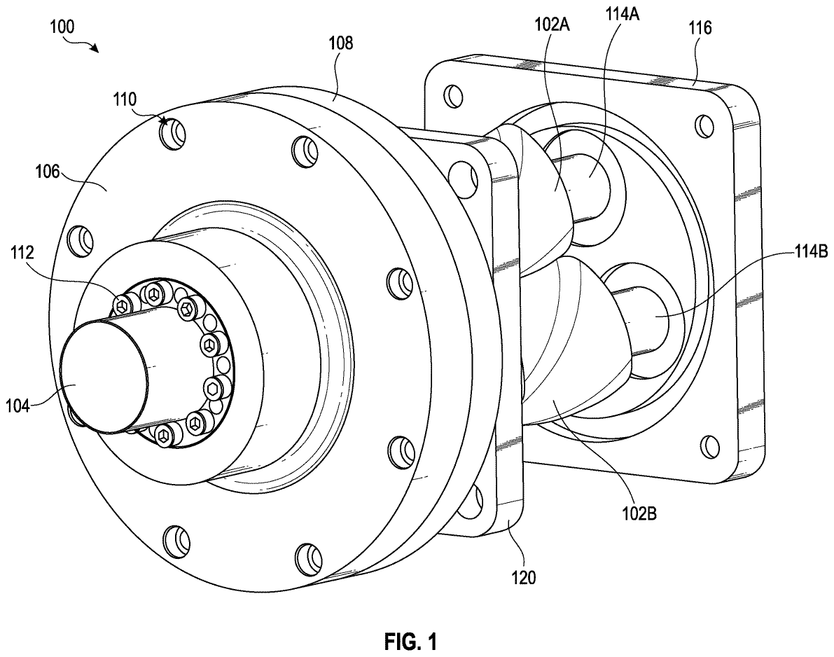

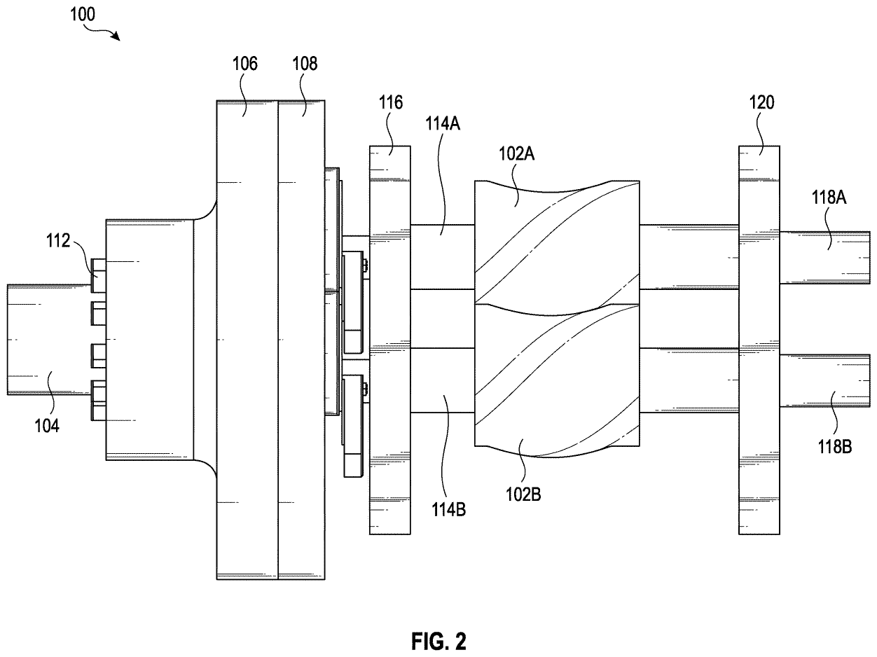

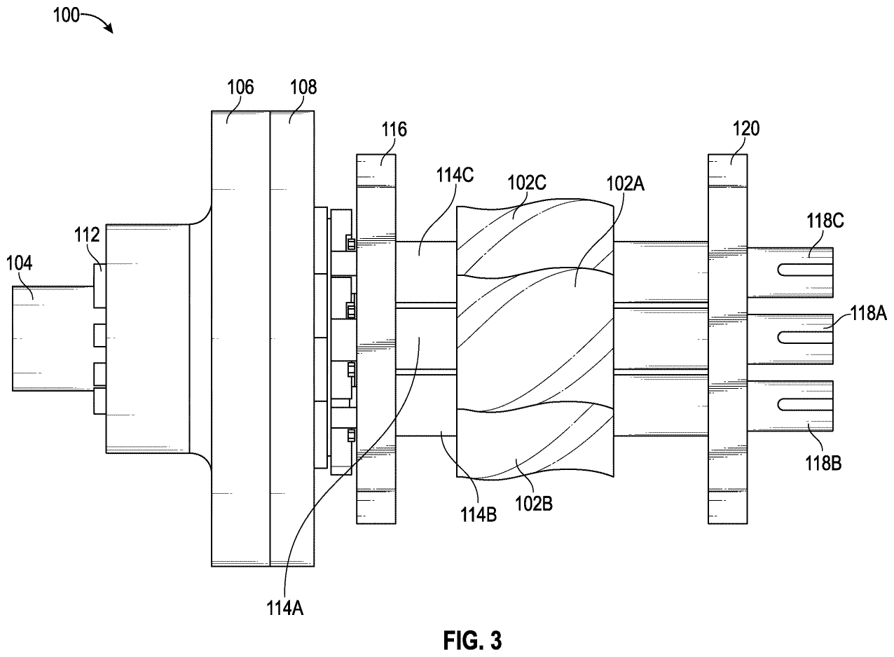

FIGS. 1-3 illustrate a front perspective view of a synchronous cam drivetrain assembly 100. The synchronous cam drivetrain assembly 100 may include a plurality of rotors 102A-C configured to drive a single output shaft 104. As will be discussed in more detail later herein, an output adapter plate 106 is coupled to an internal ring gear 108, with the single output shaft 104 being coupled to the output adapter plate 106. As the internal ring gear 108 rotates, the adapter plate 106 rotates, which thereby rotates the single output shaft 104.

The output adapter plate 106 may include a plurality of mounting holes 110 arranged in a circular pattern around a perimeter of the output adapter plate 106. The mounting holes 110 may provide attachment points for coupling the output adapter plate 106 to the internal ring gear 108. The single output shaft 104 extends outwardly from a center of the output adapter plate 106 and is coupled thereto via a keyless bushing 112. Each rotor 102A-C comprises a first shaft 114A-C passing through a first endbell 116 and a second shaft 118A-C passing through a second endbell 120, the rotors 102A-C positioned between the first endbell 116 and second endbell 120. While described herein as first shafts 114A-C and second shafts 118A-C, it will be understood that both sets of shafts may also be a single shaft with a rotor thereon, and need not be separate components. In the illustrated embodiment, the second shafts 118A-C may function as input shafts to drive rotation of the rotors 102A-C, and the first shafts 114A-C may function as cam shafts coupled to the cam lobes 124A-C such that rotation of the second shafts 118A-C is transferred to synchronous rotation of the first shafts 114A-C.

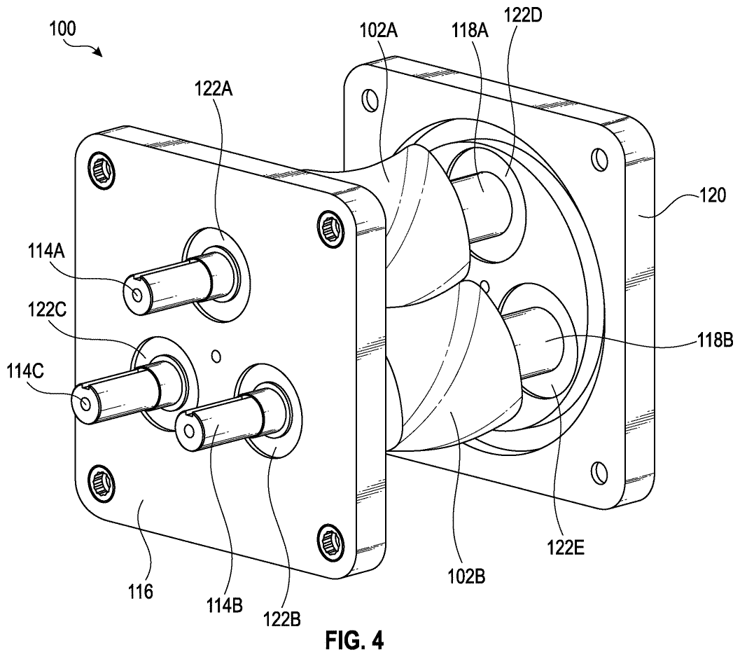

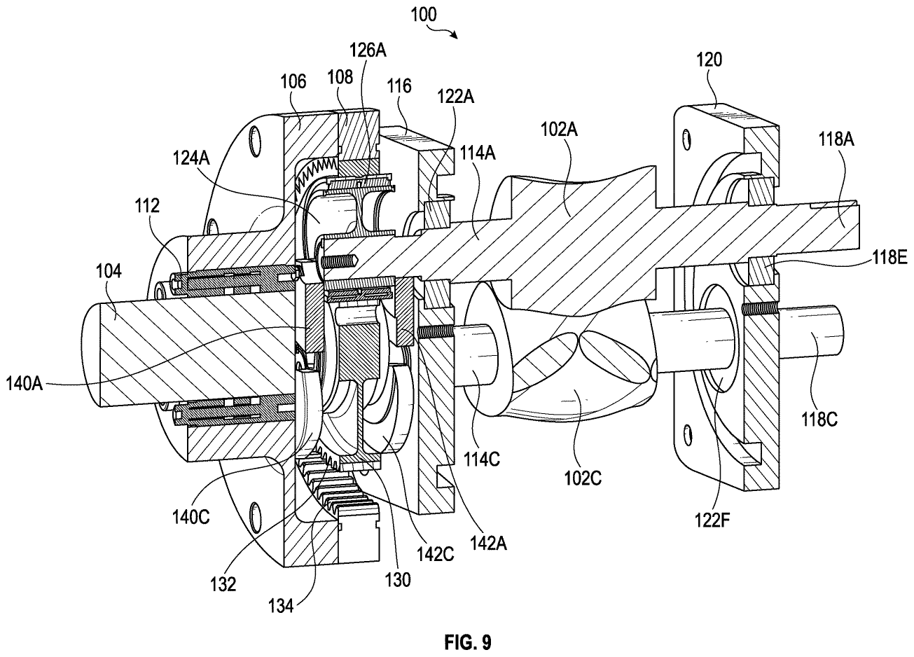

FIG. 4 illustrates the arrangement of the respective rotors 102A-C(102C not visible in this view) with the first shafts 114A-C passing through the first endbell 116, and second shafts 118A-C(118C not visible in this view) passing through the second endbell 120. A first plurality of shaft bearings 122A-C facilitate the rotation of the respective first shafts 114A-C within the first endbell 116, with a second plurality of shaft bearings 122D-F facilitating rotation of the second shafts 118A-C(it will be understood that second shaft 118C likewise has shaft bearings 122F, as shown in FIG. 9, although not visible in this view).

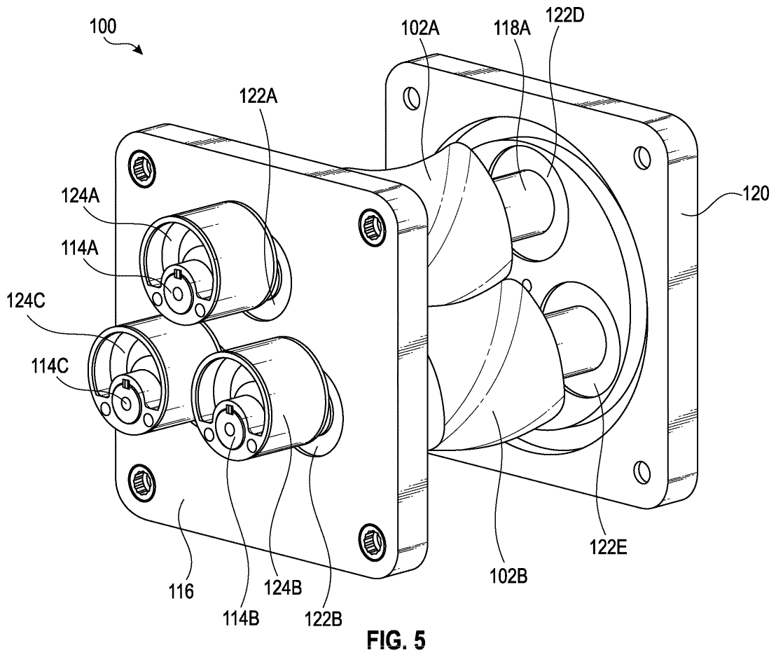

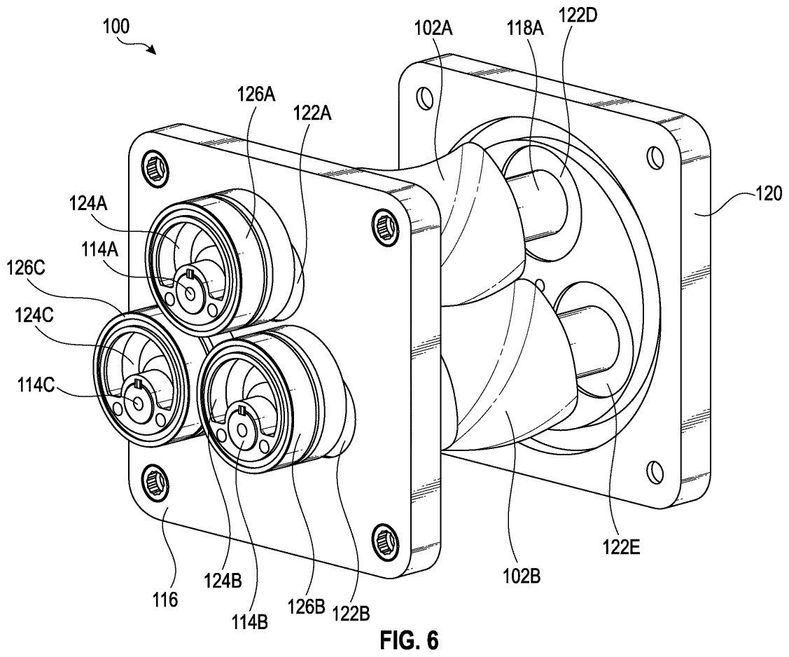

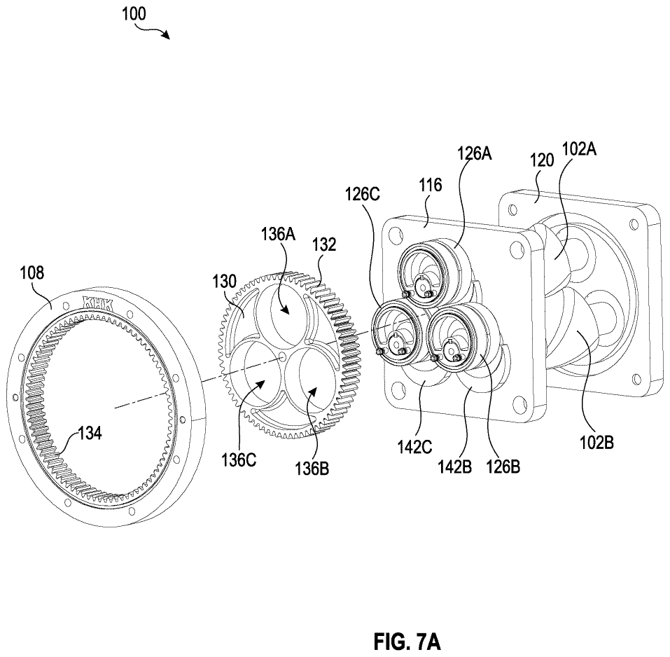

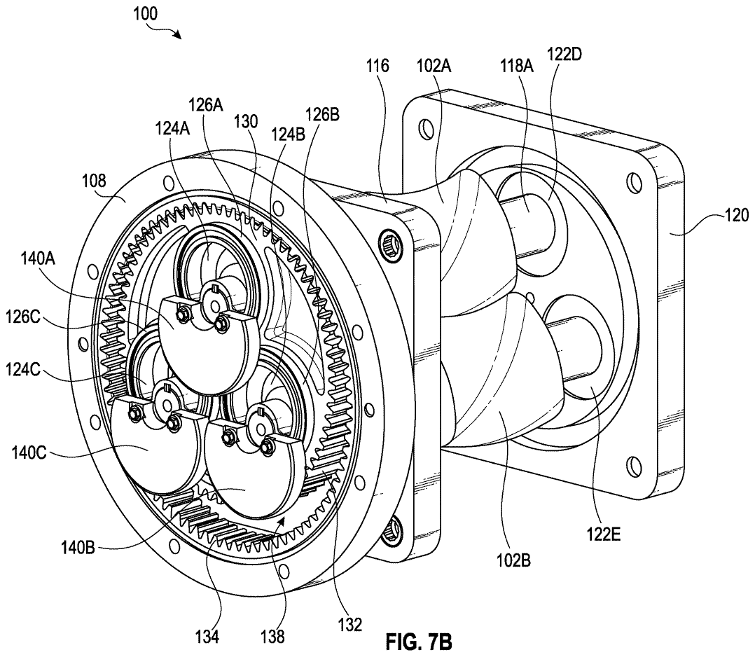

FIG. 5 illustrates a respective cam lobe 124A-C coupled to each first shaft 114A-C on a first side of the first endbell 116. All cam lobes 124A-C are configured to have the same eccentricity. FIG. 6 illustrates cam bearings 126A-C coupled to, and encircling, each cam lobe 124A-C. FIG. 7 illustrates a link gear 130 that is configured to receive each of the cam lobes 124A-C and cam bearings 126A-C therein. The link gear 130 comprises outer teeth 132 along an outer circumference that are configured to mesh with inner teeth 134 of internal ring gear 108. As shown, the inner teeth 134 of the internal ring gear 108 are on an inner face, allowing the inner teeth 134 to mesh with the outer teeth 132 of the link gear 130.

In some aspects, precise synchronization (indexing) of the plurality of rotating shafts 114A-C is maintained by the geometry of the cam lobes 124A-C as received within the receiving housing holes 136A-C of the link gear 130, optionally via the cam bearings 126A-C. Stated differently, the timing relationship between the shafts 114A-C is defined at the cam/bearing interface with the link gear 130. The meshing engagement between the link gear 130 and internal ring gear 108 is utilized primarily for torque transfer and to establish a speed relationship (gear ratio) between the link gear orbital motion and rotation of the internal ring gear 108.

As shown, the internal ring gear 108 may have an inner diameter larger than the outer diameter of the link gear 130 such that only a portion of the teeth 132 and teeth 134 are engaged with one another at any given time, forming an aperture 138 between the internal ring gear 108 and the link gear 130. In some aspects, the cam lobes 124A-C, cam bearings 126A-C, link gear 130, and internal ring gear 108 may be arranged in a common plane.

FIG. 7 also illustrates a plurality of first counterbalance weights 140A-C that may each be coupled to a respective cam lobe 124A-C. As the plurality of second shafts 118A-C rotate, each rotor 102A-C likewise rotates, which in turn rotates the first shafts 114A-C having the cam lobes 124A-C thereon. The rotating cam lobes 124A-C cause the link gear 130 to travel in a substantially non-rotative epicyclic orbit with a radius equal to the eccentricity of the cam lobes 124A-C. The link gear 130 may be mated to the internal ring gear 108, with the single output shaft 104 (FIG. 9) coupled to the internal ring gear 108, via output adapter plate 106, to receive combined rotational output.

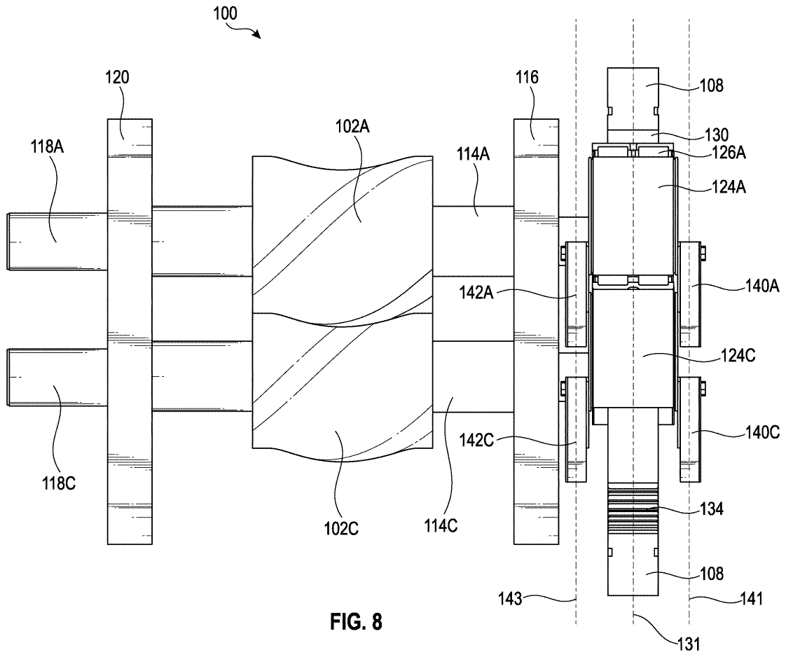

FIG. 8 illustrates a partial cutaway left side elevation view and FIG. 9 illustrates a cross-section of the cam drivetrain assembly 100. As understood, the cam lobes 124A-C, cam bearings 126A-C, link gear 130, and internal ring gear 108 are arranged in a common plane, referred to as a balancing plane 131. Further, in addition to the plurality of first counterbalance weights 140A-C, a plurality of second counterbalance weights 142A-C may be positioned on an opposite side of each respective cam lobe 124A-C. In other words, each cam lobe 124A-C is interposed between a respective pair of counterbalance weights. As understood, the plurality of first counterbalance weights 140A-C are in a first balancing correction plane 141, with the plurality of second counterbalance weights 142A-C being in a second balancing correction plane 143, with the balancing plane 131 therebetween.

As the plurality of cam lobes 124A-C rotate from the starting position, the link gear 130 may travel in a substantially non-rotative epicyclic orbit within the internal ring gear 108. The link gear 130 may orbit with a radius equal to the eccentricity of the cam lobes 124A-C while the link gear 130 does not rotate, or rotates only minimally, about a center of the link gear 130. The substantially non-rotative epicyclic motion of the link gear 130 may be characterized by translation of the link gear 130 in a circular orbital path while the link gear 130 maintains a fixed or substantially fixed angular orientation. As the plurality of first shafts 114A-C rotate synchronously, the cam lobes 124A-C may cause the link gear 130 to translate within the internal ring gear 108. The link gear 130 may maintain mesh engagement with the internal ring gear 108 throughout the substantially non-rotative epicyclic orbit. The external teeth 132 of the link gear 130 may remain in continuous engagement with the internal teeth 134 of the internal ring gear 108 as the link gear 130 orbits.

The progression from the starting position through the 45-degree rotation position to the 90-degree rotation position, and onward, may demonstrate the synchronized rotation of the plurality of shafts 114A-C. All cam lobes 124A-C may rotate together with eccentricities of all cam lobes 124A-C oriented in the same direction throughout rotation. The substantially non-rotative epicyclic orbit of the link gear 130 transfers torque from the rotors 102A-C to the internal ring gear 108 and to a single output shaft 104 coupled to the internal ring gear 108.

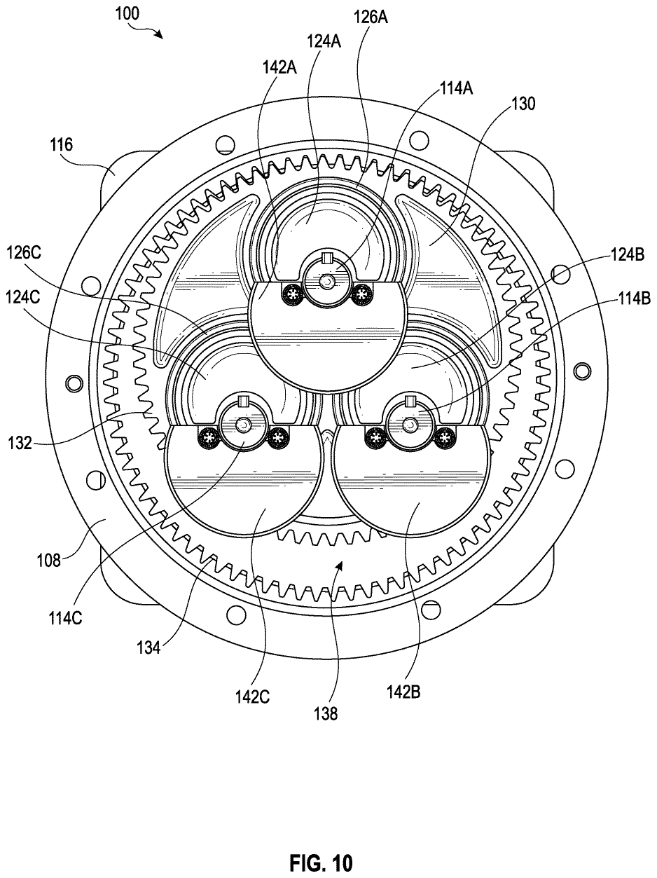

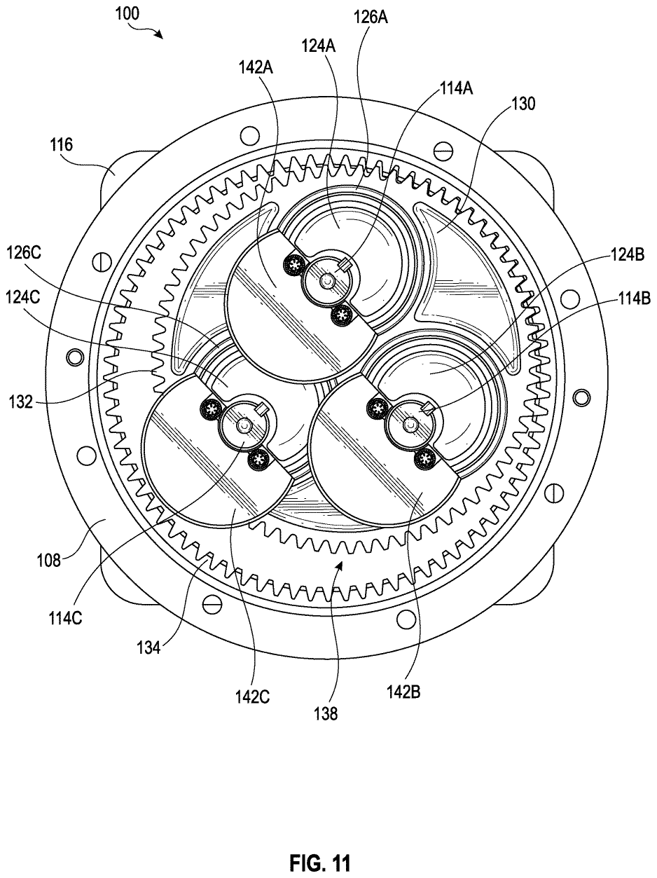

FIG. 10 illustrates a front elevation view with the cam lobes 124A-C and counterbalance weights 142A-C in a first, starting position (e.g., 0-degree rotation). FIG. 11 illustrates a front elevation view with the cam lobes 124A-C and counterbalance weights 142A-C in a second, rotated position (e.g., 45-degree rotation).

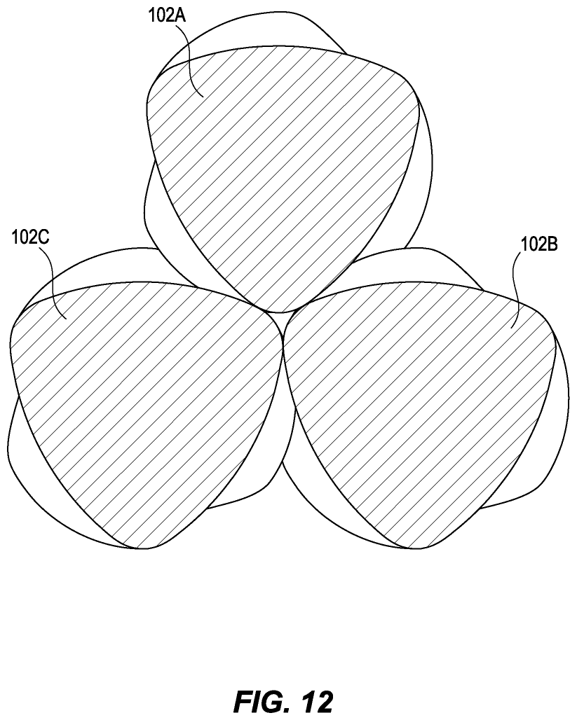

FIG. 12 illustrates a front elevation view cross-section of the configuration of the rotors 102A-C. As appreciated, the rotors 102A-C may be helical or straight in shape, each having a generally triangular, tri-lobed, or otherwise non-circular cross-section. The helical configuration of the rotors 102A-C may enable the rotors 102A-C to function in applications such as compressors, expanders, or pumps. While shown with three rotors 102A-C, it will be appreciated that other rotor numbers and configurations may be used without departing herefrom. For example, in some aspects the synchronous drivetrain assembly 100 may comprise four rotors, each having a general ellipse, two-lobed, or otherwise non-circular cross-section.

As appreciated, the synchronous cam drivetrain assembly 100 may demonstrate a coplanar arrangement of the cam lobes 124A-C, cam bearings 126A-C, link gear 130, and internal ring gear 108. In some aspects, all force-transmitting components (e.g., cam lobes 124A-C, cam bearings 126A-C, link gear 130, and internal ring gear 108) may be positioned along a common plane. The coplanar arrangement may reduce or eliminate cantilevered loading conditions that could cause twisting, distortion, or deflection of components. As shown and described, in some cases, counterbalance weights 140A-C, 142A-C may be positioned on both sides of the common plane to provide symmetrical balance correction for the rotating assembly.

The internal ring gear 108 surrounds the link gear 130 and provides an interface for torque transfer to the output shaft 104. The overall arrangement illustrates how torque may be transmitted from the plurality of shafts 114A-C, 118A-C through the cam lobes 124A-C to the link gear 130 and to the internal ring gear 108 to the single output shaft 104 while maintaining precise synchronization between the rotating components. The cam lobes 124A-C have the same eccentricity, offset, or crank-throw distance.

The link gear 130 may travel in a substantially non-rotative epicyclic orbit while meshing with the internal ring gear 108. The substantially non-rotative epicyclic orbit of the link gear 130 within the internal ring gear 108 may transfer torque to the single output shaft 104.

Cam bearings 126A-C may be positioned between the cam lobes 124A-C and the receiving holes of the link gear 130. The cam bearings 126A-C may facilitate rotation of the cam lobes 124A-C within the link gear 130 while maintaining synchronization between the plurality of cam shafts 114A-C. In some aspects, the cam bearings 126A-C may be preloaded to reduce or eliminate backlash. Preloading the bearings may limit backlash to remaining internal bearing clearances. Reduction or elimination of backlash may improve synchronization precision between the plurality of cam shafts 114A-C.

In some cases, the single output shaft 104 may be coupled to a generator, motor, or an alternator. The gear mesh between the link gear 130 and the internal ring gear 108 may create a gear ratio that produces a speed mismatch between machine speed and output shaft speed 104. In some aspects, a gearbox may be positioned between the single output shaft 104 and the generator, motor, or alternator. The gearbox may adjust output shaft speed to match a speed of the generator, motor, or alternator.

The precise synchronization provided by the synchronous cam drivetrain 100 may enable smaller running clearances or gaps between adjacent rotors 102A-C. Reduction of running clearances between adjacent rotors 102A-C may correlate to improved machine efficiency with a reduction in leakage between adjacent rotors 102A-C. For example, by using precise synchronization and limiting the amount of backlash or independent angular rotation, rotor interference during operation is avoided, which reduces or prevents seizure or damage to rotating components.

The synchronous cam drivetrain 100 may be applicable to planetary rotor expander machines, planetary rotor compressor machines, or other rotating machinery where the rotors 102A-C include intermeshing helical rotor profiles. The coplanar arrangement of the cam lobes 124A-C, cam bearings 126A-C, link gear 130, and internal ring gear 108 may enable high torque load transfer without edge loading or uneven loading of cam bearings 126A-C. In some aspects, the synchronous cam drivetrain 100 may be configured for high pressure operation. In some cases, the synchronous cam drivetrain 100 may be configured for high load operation. The combination of precise synchronization and high load carrying capacity may enable the synchronous cam drivetrain 100 to be used in applications where both high efficiency and high pressure or high load operation are desired.

The gear mesh between the link gear 130 and the internal ring gear 108, with the substantially non-rotative epicyclic orbit of the link gear 130 within the internal ring gear 108, may create a gear ratio. The gear ratio may be determined by the following formula:
In some aspects, the gear ratio may be expressed as: Gear Ratio=Z₁/(Z₁−Z₂). As used herein, “gear ratio” refers to a relationship between (i) an orbital frequency of the link gear 130 within the internal ring gear 108 and (ii) a rotational speed of the internal ring gear 108, based on respective tooth counts.

$$Gear Ratio = \frac{{Z}_{1}}{( {Z}_{1} - {Z}_{S} )}$$

Where Z₁ is equal to the tooth count of the internal ring gear 108 and Z₂ is equal to the tooth count of the common link gear 130.

For example, a ring gear (Z₁) with 80 teeth and a link gear (Z₂) with 70 teeth would create a gear ratio of 8:1. The link gear will orbit 8 times for every one revolution of the ring gear:

$$Gear Ratio = \frac{80}{( 80 - 70 )} = \frac{80}{10} = \frac{8}{1} = 8$$

This gear ratio creates a speed mismatch between machine speed and the drivetrain output shaft speed. The output shaft 104 is typically coupled to a generator, motor, or alternator which operate at speeds closer to the machine speed for efficiency. This can be easily remedied by including a gear box between the drivetrain output shaft 104 and the generator, motor, or alternator to increase the output shaft speed to match the speed of the machine.

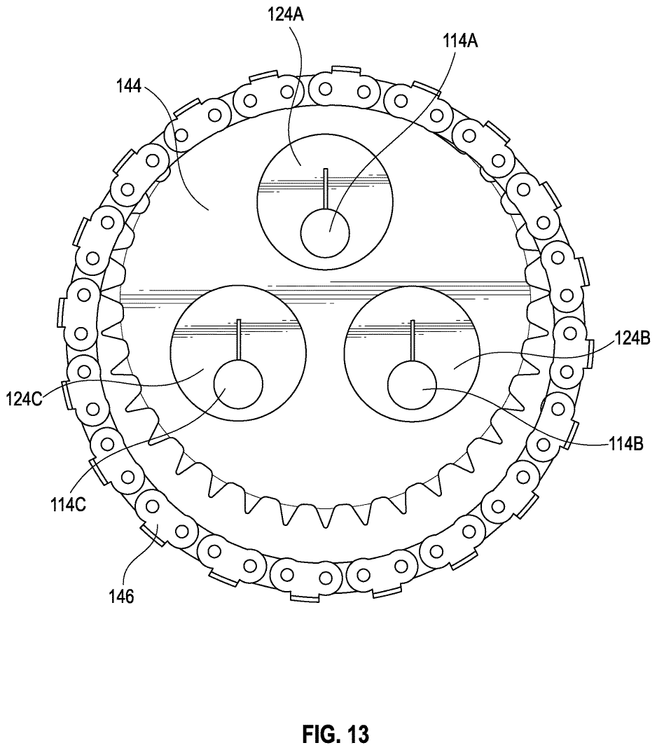

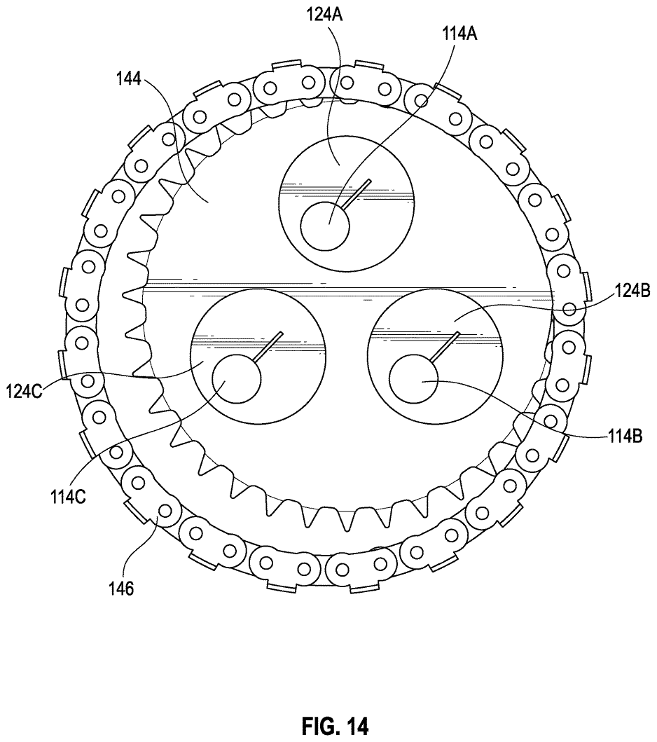

FIG. 13 illustrates a front elevation view of an alternate embodiment wherein each cam lobe 124A-C is coupled to a sprocket 144, the sprocket 144 configured to engage a roller chain 146. In some aspects, the roller chain 146 may be constrained (e.g., rigidly mounted, supported, and/or guided) so as to form a generally circular, fixed chain ring that replaces the internal ring gear 108, while the sprocket 144 replaces the link gear 130. In operation, the sprocket 144 may undergo a substantially non-rotative epicyclic orbit relative to the chain 146 as driven by the cam lobes 124A-C, thereby transferring torque and establishing a speed relationship analogous to the internal ring gear/link gear embodiments described above. FIG. 13 illustrates a starting position (e.g., 0-degree rotation). FIG. 14 illustrates a front elevation view with the cam lobes 124A-C and sprocket 144 in a second, rotated position (e.g., 45-degree rotation).

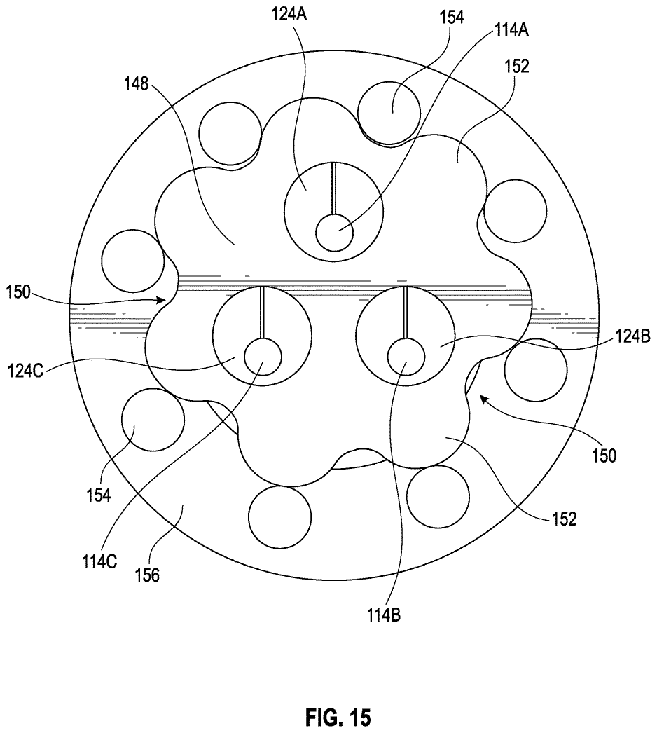

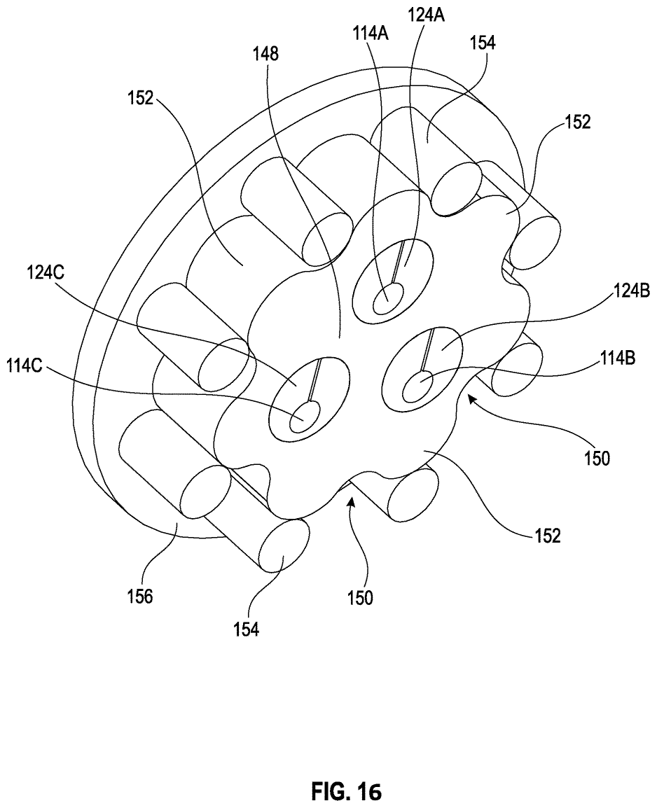

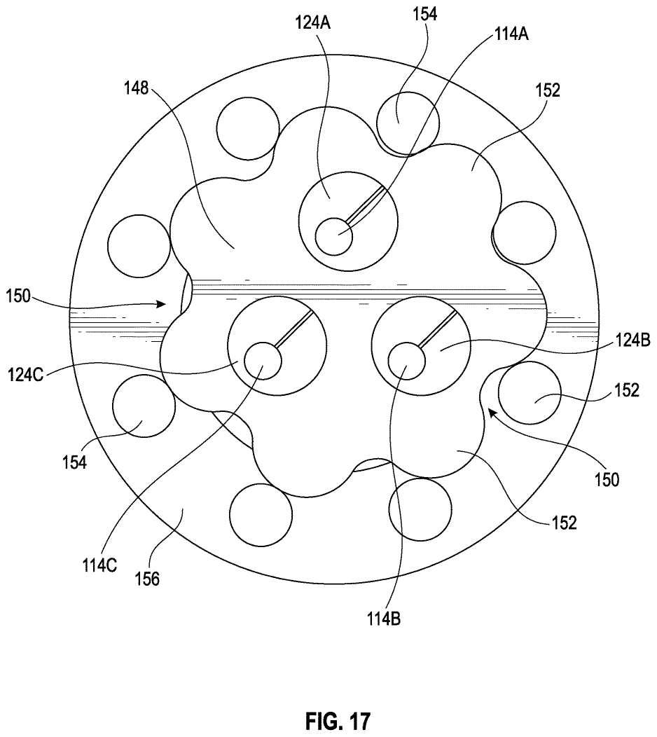

FIGS. 15-16 illustrate an alternate embodiment utilizing a modified cycloidal drive. In this embodiment, each cam lobe 124A-C is coupled to a cycloidal disc 148 having a plurality of valleys 150 formed between peaks 152. The valleys 150 and peaks 152 interact with a plurality of pins 154 extending forwardly from an axial face of an output ring 156. In some aspects, the cycloidal disc 148 may be constrained to undergo a substantially non-rotative epicyclic orbit, and the output ring 156 may be configured to rotate and provide a combined output in response to interaction between the valleys 150, the peaks 152, and the pins 154. In some aspects, relative to a traditional cycloidal drive, the roles of components may be reversed such that a typical stationary outer ring member (e.g., output ring 156) rotates while a typical rotating central output member is stationary (omitted from this configuration but the same resultant motion of the cycloidal disc is achieved with a plurality of cam lobes), thereby promoting rolling-type contact between the cycloidal disc and output ring pins and reduced backlash and wear. FIGS. 15-16 illustrate a first, starting position (e.g., 0-degree rotation). FIG. 17 illustrates a front elevation view with the cam lobes 124A-C and cycloidal disc 148 in a second, rotated position (e.g., 45-degree rotation).

As appreciated from the foregoing, the synchronous cam drivetrain 100 may address limitations associated with conventional approaches to synchronizing and combining output from multiple rotating shafts. The coplanar arrangement shown and described may position torque forces along the common plane, which may reduce or eliminate moments that could otherwise cause twisting, distortion, or deflection in cantilevered configurations. The reduction or elimination of such moments may result in more even bearing loading compared to cantilevered crank arm arrangements. In some aspects, the coplanar arrangement may enable greater load carrying capacity than cantilevered configurations, which may expand applicability to high-load and high-pressure applications.

The synchronous cam drivetrain 100 may simplify balance correction compared to cantilevered arrangements. In some cases, as shown and described, counterbalance weights 140A-C, 142A-C may be positioned on planes located on either side of an unbalanced, common plane to provide symmetrical balance correction. The symmetrical positioning of counterbalance weights 140A-C, 142A-C may replace complex couple unbalance correction approaches that may be associated with cantilevered configurations. In some aspects, the simplified balancing approach may reduce machine size compared to configurations that utilize complex couple unbalance correction.

The synchronous cam drivetrain 100 may provide precise synchronization between a plurality of shafts 114A-C, 118A-C. Backlash may be limited to internal clearances of cam bearing 126A-C positioned between cam lobes 124A-C and receiving housing holes 136A-C of the link gear 130. In some cases, the cam bearings 126A-C may be preloaded to reduce or eliminate backlash. Reduction or elimination of backlash may improve synchronization precision compared to gear-based synchronization systems that exhibit backlash between meshing gear teeth. The synchronous cam drivetrain 100 may maintain precise synchronization at high loads and during speed reversals.

In some aspects, the precise synchronization provided by the synchronous cam drivetrain 100 may enable smaller running clearances between adjacent rotors 102A-C. Reduction of running clearances between adjacent rotors 102A-C may correlate to improved machine efficiency with a reduction in leakage between adjacent rotors 102A-C.

The synchronous cam drivetrain 100 may provide quieter and smoother operation compared to gear-based, belt-driven, or chain-driven synchronization systems. The synchronous cam drivetrain 100 may be applicable to planetary rotor expander machines, planetary rotor compressor machines, pumps, or other rotating machinery where precise synchronization and high torque load transfer are desired.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

1. A synchronous cam drivetrain, comprising:
a plurality of shafts, each shaft having a cam lobe at an end thereof, wherein all cam lobes have a same eccentricity, and wherein a direction of eccentricity for all cam lobes is positioned in a same direction;
a link gear having a plurality of receiving housing holes, wherein a number of the receiving housing holes corresponds to a number of the cam lobes, wherein each receiving housing hole is separated from adjacent receiving housing holes by distances equal to shaft separation distances between the plurality of shafts, and wherein the cam lobes are fitted within the receiving housing holes of the link gear;
an internal ring gear coupled to the link gear; and
a single output shaft coupled to the internal ring gear,
wherein, as the plurality of shafts rotate, the plurality of shafts are synchronized by the link gear such that the plurality of shafts rotate unidirectionally, and wherein rotation of the plurality of shafts causes the link gear to travel in a substantially non-rotative epicyclic orbit with a radius equal to the eccentricity of the cam lobes.

2. The synchronous cam drivetrain of claim 1, wherein the link gear comprises external teeth around an outer circumference of the link gear.

3. The synchronous cam drivetrain of claim 2, wherein the internal ring gear comprises internal teeth that mesh with the external teeth of the link gear.

4. The synchronous cam drivetrain of claim 1, wherein the cam lobes, cam bearings positioned between the cam lobes and the receiving housing holes, the link gear, and the internal ring gear are arranged along a common plane.

5. The synchronous cam drivetrain of claim 1, further comprising bearings positioned between the cam lobes and the receiving housing holes of the link gear.

6. The synchronous cam drivetrain of claim 5, wherein the bearings are preloaded to reduce or eliminate backlash.

7. The synchronous cam drivetrain of claim 1, further comprising counterbalance weights positioned on opposite sides of a balancing plane.

8. The synchronous cam drivetrain of claim 1, wherein the single output shaft is configured to be coupled to a generator, motor, or an alternator.

9. The synchronous cam drivetrain of claim 8, further comprising a gear box positioned between the single output shaft and the generator, motor, or alternator.

10. The synchronous cam drivetrain of claim 1, wherein the plurality of shafts are coupled to a plurality of rotors having helical, or straight, rotor profiles configured to intermesh with one another.

11. The synchronous cam drivetrain of claim 1, wherein the link gear comprises a sprocket and the internal ring gear comprises a roller chain constrained to form a generally circular chain ring engaged with the sprocket.

12. The synchronous cam drivetrain of claim 1, wherein the link gear and internal ring gear are configured as a modified cycloidal drive.

13. A method of synchronizing a plurality of shafts and combining rotational output from the plurality of shafts into a single output shaft, the method comprising:
providing a plurality of shafts, each shaft having a cam lobe at an end thereof, wherein all cam lobes have a same eccentricity, and wherein a direction of eccentricity for all cam lobes is positioned in a same direction;
fitting the cam lobes within receiving housing holes of a link gear, wherein a number of the receiving housing holes corresponds to a number of the cam lobes, and wherein each receiving housing hole is separated from adjacent receiving housing holes by distances equal to shaft separation distances between the plurality of shafts;
rotating the plurality of shafts such that the link gear synchronizes the plurality of shafts to rotate unidirectionally, wherein rotation of the plurality of shafts causes the link gear to travel in a substantially non-rotative epicyclic orbit with a radius equal to the eccentricity of the cam lobes; and
transferring torque from the link gear to an internal ring gear coupled to the link gear, wherein the single output shaft is coupled to the internal ring gear.

14. The method of claim 13, further comprising positioning cam bearings between the cam lobes and the receiving housing holes of the link gear.

15. The method of claim 14, further comprising preloading the cam bearings to reduce or eliminate backlash.

16. The method of claim 13, further comprising arranging the cam lobes, cam bearings, the link gear, and the internal ring gear along a common plane.

17. The method of claim 13, further comprising positioning counterbalance weights on opposite sides of a balancing plane.

18. The method of claim 13, wherein the plurality of shafts are part of, or are coupled to, a planetary rotor machine.

19. The method of claim 13, wherein the link gear comprises outer teeth and the internal ring gear comprises inner teeth that mesh with the outer teeth.

20. The method of claim 19, wherein an inner diameter of the internal ring gear is larger than an outer diameter of the link gear such that only a portion of the inner teeth and the outer teeth are engaged at a given time to define an aperture between the internal ring gear and the link gear.
